(19) United States
(12) Patent Application Publication
(10) Pub. No.: US 2012/0320104 A1
(43) Pub. Date: Dec. 20, 2012

(54) IMAGE PROCESSING DEVICE, ELECTRO-OPTIC DEVICE, ELECTRONIC APPARATUS, AND IMAGE PROCESSING METHOD

(75) Inventor: Toshiaki TOKUMURA, Suwa-shi (JP)

(73) Assignee: SEIKO EPSON CORPORATION, Tokyo (JP)

(21) Appl. No.: 13/525,011

(22) Filed: Jun. 15, 2012

(30) Foreign Application Priority Data
Jun. 17, 2011 (JP) 2011-134847

(51) Int. Cl. G09G 5/10

(52) U.S. Cl. 345/690

(57) ABSTRACT

A compensation correction value of between two reference locations neighboring each other is computed based on correction values of a plurality of reference locations set to be spaced apart from each other in an X direction and gradation values of pixels corresponding to each location in the X direction is corrected.

### CROSS REFERENCES TO RELATED APPLICATIONS

The entire disclosure of Japanese Patent Application No. 2011-134847, filed Jun. 17, 2011 is expressly incorporated herein by reference.

### BACKGROUND

1. Technical Field

The present invention relates to a technology for suppressing gradation irregularity of an image displayed using a plurality of pixels.

2. Related Art

FIG. 12 shows an electro-optical device in which a plurality of pixels P corresponding to the intersections of a plurality of scanning lines 12 extending in an X direction and a plurality of signal lines 14 extending in a Y direction are arranged in a matrix pattern has been used in the related art. The plurality of signal lines 14 are divided into a plurality of blocks B for every predetermined number of lines. An image signal according to a gradation value designated for each pixel P is supplied to each signal line 14 for each block B in a time division scheme.

As illustrated above, in a configuration of supplying an image signal for each block B with respect to each signal line 14 in a time division scheme, there is a problem in that a gradation irregularity (referred to as “vertical line irregularity” hereinafter) occurs in a vertical line corresponding to a boundary of blocks B neighboring each other. In JP-A-2006-47971, a technology for suppressing the vertical line irregularity is disclosed which performs correction of an image signal line 14 supplied to a signal of both ends of each block B.

However, since a transmission distance of an image signal (distance between an input terminal of an image signal and each signal line) or a supply point of the image signal to each signal line 14 differs with blocks B, degrees of a vertical line irregularity between blocks B are changed according to a location in an X direction. However, in a technology of JP-A-2006-47971, since correction values applied to compensation of an image signal of each signal line 14 are commonly used with respect to a plurality of blocks B, there is a problem that a difference of a vertical line irregularity according to a location in the X direction cannot be sufficiently compensated.

A configuration of maintaining a compensation value for each signal line 14 in a storage circuit can be considered such that an image signal supplied to each signal line 14 may be separately corrected. However, there is a problem in that a storage capacity necessary for storage of the correction values is increased. The foregoing description has illustrated a case where an image signal is supplied to each signal line for each block B in a time division scheme. However, for example, a vertical line irregularity of a block B unit may occur in the same manner in a configuration in which a process sequentially supplying an image signal to a plurality of signal lines 14 in each block B is performed for a plurality of blocks B in parallel.

### SUMMARY

An advantage of some aspects of the invention is that a gradation irregularity is effectively prevented while reducing a storage capacity necessary in storing a compensation value.

One aspect of the invention is an image processing device generating an image signal designating each gradation value of a plurality of pixels arranged in a matrix pattern in a pixel unit of an electro-optical device in a first direction (for example, X direction) and a second direction intersecting the first direction. The image processing device includes a correction value acquiring unit acquiring each correction value of a plurality of reference locations set to be spaced apart from each other in a first direction, an interpolation unit interpolating the correction value acquired by a correction value acquiring unit for two reference locations neighboring each other and computing the correction value of each of the two reference locations, and a corrector correcting a gradation value of a pixel corresponding to each location in the first direction according to the correction value of the location. Using this configuration, since a correction value is separately generated with respect to each location in a first direction, although a degree of gradation irregularity such as a vertical line irregularity is different according to a location in the first direction, a gradation irregularity of each location may be efficiently reduced to achieve a uniform display. Since a correction value of each of the two reference locations is computed by interpolating the a correction value of each of the two reference locations, the storage capacity necessary for maintaining the correction values can be reduced.

Another aspect of the invention is an image processing device. The image processing device includes a storage unit storing a correction value with respect to a first reference location of a plurality of reference locations, and storing a relative value with reference to the correction value of the first reference location with respect to a second reference location other than the first reference location. The correction value acquiring unit computes a correction value of a second reference location from the relative value stored in the storing unit and the correction value of the first reference location. In this configuration, since the correction value of the second reference location is stored in the storage unit as a relative value with respect to the correction value of the first reference location, for example, by changing the correction value of the first reference value, the correction values of each reference location can be changed collectively.

Still another aspect of the invention is an electro-optical device. The electro-optical device includes a pixel unit having a plurality of pixels arranged in a first direction and in a second direction crossing each other in a matrix pattern, an image processor of each of the foregoing aspects generating an image signal designating a gradation value of each pixel, and a driver driving each pixel according to the image signal generated by the image processor. Consequently, the same function and effect as in the image processing device of the invention are achieved. The electro-optical device of the invention is a display for displaying an image, and may be installed in various types of electronic apparatus (for example, portable phones or projection displays).

The invention may be implemented as an image processing method for generating an image signal designating a gradation value of each pixel in an electro-optical device. The image processing method of the invention includes acquiring each correction value of a plurality of reference locations set to be spaced apart from each other in a first direction, computing a correction value of each location between two reference neighboring locations by interpolating the correction values acquired with respect to the two reference locations, and correcting the gradation values of the pixels corresponding to each location in the first direction according to the correction of the location. In the processing method described above, the same functions and effect are implemented as in the image processing device of the invention.

### BRIEF DESCRIPTION OF THE DRAWINGS

The invention will be described with reference to the accompanying drawings, wherein like numbers reference like elements.

FIG. 1 is a block diagram illustrating an electro-optical device according to a first embodiment of the invention;

FIG. 2 is a circuit diagram illustrating a pixel;

FIG. 3 is a timing chart illustrating an operation of an electro-optical device;

FIG. 4 is a block diagram illustrating a signal line driver;

FIG. 5 is a block diagram illustrating an image processor;

FIG. 6 is a block diagram illustrating a correction processor;

FIG. 7 is a diagram illustrating a content storage and interpolation process of a memory;

FIG. 8 is a diagram illustrating a content storage and interpolation process of a storage circuit according to a second embodiment;

FIG. 9 is a perspective view illustrating a form of an electronic apparatus (personal computer;

FIG. 10 is a perspective view illustrating a form of an electronic apparatus (portable phone);

FIG. 11 is a perspective view illustrating a form of an electronic apparatus (projection display); and

FIG. 12 is a block diagram illustrating a problem of a related art.

### DESCRIPTION OF EXEMPLARY EMBODIMENTS

### First Embodiment

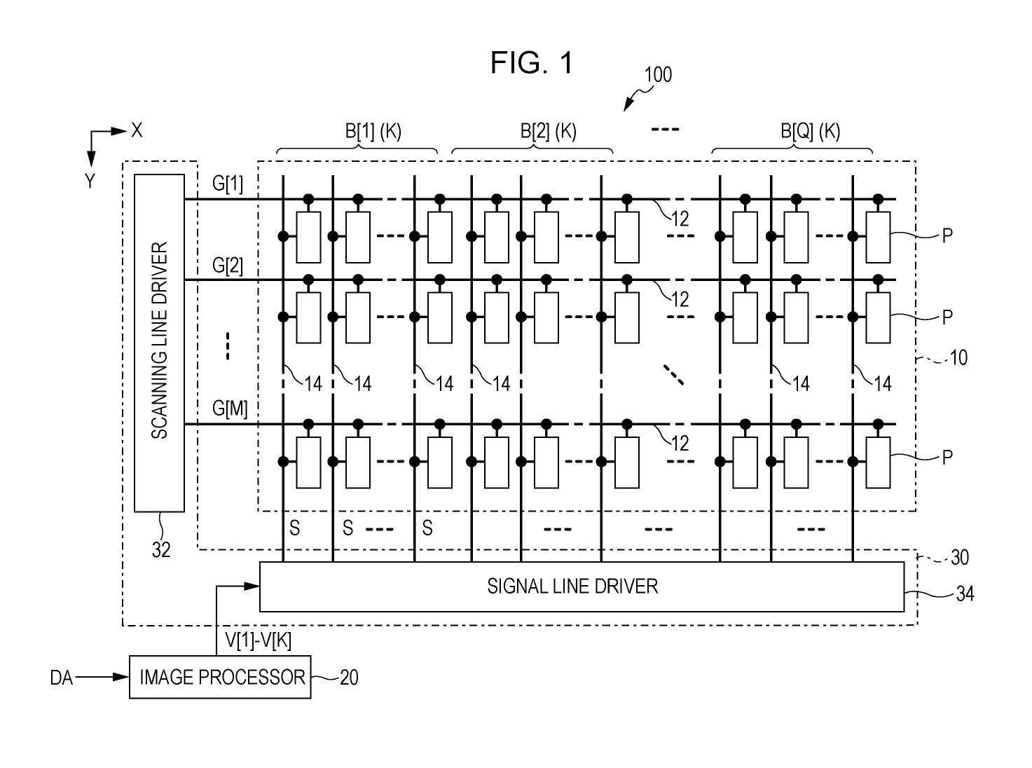

FIG. 1 is a block diagram illustrating an electro-optical device 100 according to a first embodiment of the invention. The electro-optical device 100 is a display body displaying an image, which is a liquid crystal device installed in various electronic devices. As shown in FIG. 1, the electro-optical device 100 includes a pixel unit 10 in which a plurality of pixels (pixel circuits) P are arranged in a plane, an image processor 20 processing image data DA provided from a higher-level device and generating image signals V[1] to V[K] of K system (K is an natural number equal to or greater than 2), and a driver 30 driving each pixel P in the pixel unit 10. The driver 30 includes a scanning line driver 32 and a signal line driver 34.

In the pixel unit 10, M scanning lines 12 extending in an X direction an N signal lines 14 extending in a Y direction are formed (M and N are a natural number). A plurality of pixels P are arranged at locations corresponding to intersections of the respective scanning lines 12 and respective signal lines 14, and arranged in a matrix pattern of longitudinal M rows x transverse N columns in the X direction and the Y direction crossing each other. As shown in FIG. 1, N signal lines 14 in the pixel unit 10 are divided into Q blocks B[1] to B[Q] of (Q=N/K) in units of K corresponding to a total number of image signals V[1] to V[K].

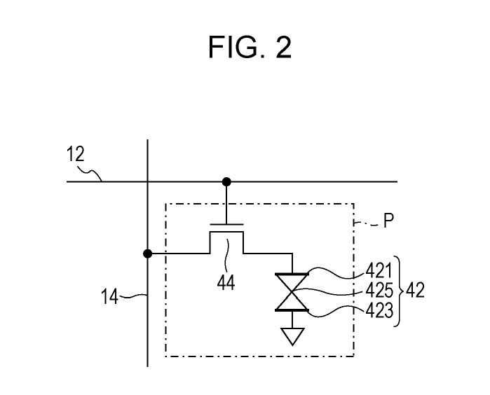

FIG. 2 is a circuit diagram illustrating a pixel P. As shown in FIG. 2, each pixel P includes a liquid crystal element 42 and a selection switch 44. The liquid crystal element 42 is an electro-optical element composed of a pixel electrode 421 and a common electrode 423 facing each other, and a liquid crystal 425 provided between the pixel electrode 421 and the common electrode 423. The pixel electrodes 421 are provided to be spaced apart from each other for each pixel P, and the common electrodes 423 are continuously distributed through a plurality of pixels P. A transmittance (display gradation) of the liquid crystal element 42 varies by controlling orientation of the liquid crystal 425 according to a voltage applied between the pixel electrode 421 and the common electrode 423. For example, the selection switch 44 is configured by a thin film transistor. When the scanning line 12 is selected, it is switched to on state to conduct the pixel electrode 421 and the signal line 14. Further, an auxiliary capacitor connecting to the liquid crystal element 42 in parallel is not shown. Moreover, a configuration of the pixel P may be suitably changed.

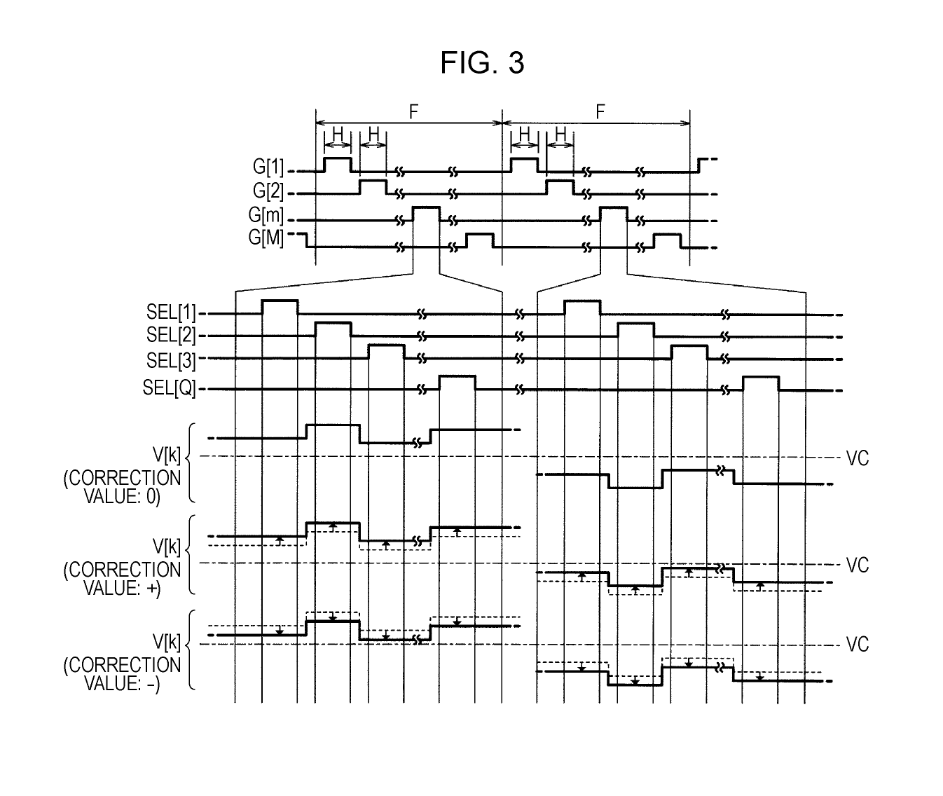

The scanning line driver 32 of FIG. 1 supplies scan signals G[1] to G[M] to scanning lines 12, respectively to sequentially select M scanning lines 12 for each horizontal scanning period H, respectively. As shown in FIG. 3, a scanning signal G[m] supplied to the scanning lines 12 an m-th row (m=1−M) is set to active level (electric potential meaning selection of the scanning line 12) in an m-th horizontal scanning period H of M horizontal scanning periods H in each vertical scanning period F. If the scanning line driver 32 selects the m-th row scanning line 12, selection switches 44 of the m-th N row pixels P are switched to on-state.

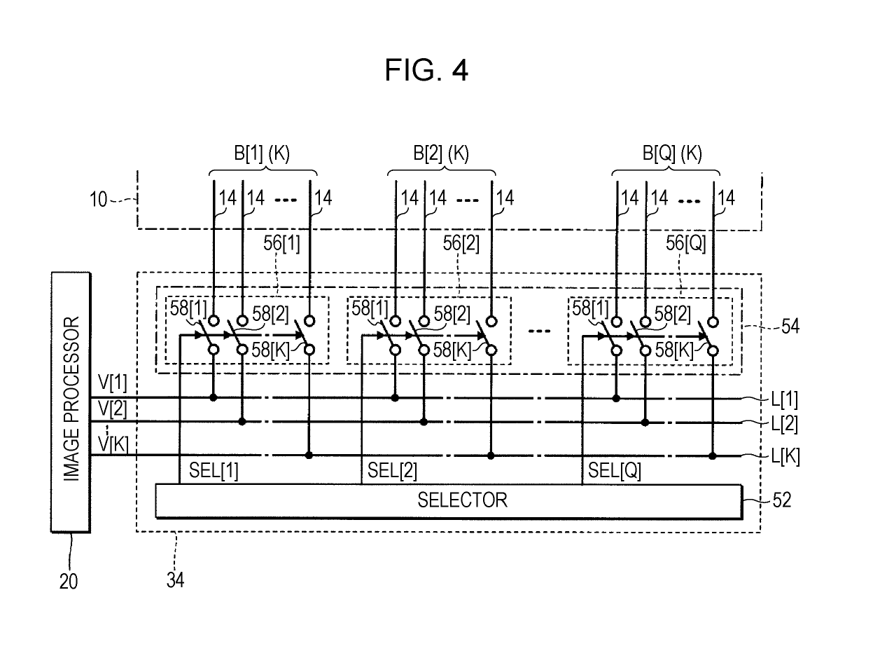

FIG. 4 is a block diagram illustrating a signal line driver 34. As illustrated in FIG. 4, the signal line driver 34 and the image processor 20 are connected to each other by K image signal lines L[1] to L[K]. The image signal V[k] generated by the image processor 20 is supplied to the signal line driver 34 through the image signal line L[K]. The signal line driver 34 sequentially acquires the image signals V[1] to V[K] supplied from the image processor 20 in synchronization with selection of a scanning line 12 by the scanning line driver 32 and supplies them to N signal lines 14 as a gradation signal S, respectively.

As shown in FIG. 4 the signal line driver 34 includes a selector 52 and an output circuit 54. The selector 52 generates selection signals SEL[1] to SEL[Q] of a Q system corresponding to a total number of blocks B[1] to B[Q]. As illustrated in FIG. 3, the selection signals SEL[1] to SEL[Q] are sequentially set to active level (electric potential meaning selection of each of blocks B[1] to B[Q]) in each horizontal scanning period H.

The output circuit 54 of FIG. 4 includes Q unit circuits 56[1] to 56[Q] corresponding to a total number of blocks B[1] to B[Q]. Each unit circuit 56[q](q=1−Q) includes K switches 58[1] to 58[K] corresponding to a total number of the image signals V[1] to V[K]. A k-th switch 58[k] in the unit circuit 56[q] is interposed between a k-th signal line 14 and an image signal line L[k] in a block B[q] to control electric connection (conduct/non-conduct) between the k-th signal line 14 and image signal line L[k]. If a selection signal SEL[q] supplied from the selector 52 is set to active level, K switches 58[1] to 58[K] in the unit circuit 56[q] switching to on-state simultaneously. Accordingly, the image signal V[k] supplied to the image signal line L[k] is supplied to a k-th signal line 14 in the block B[q] through a switch 58[k] in the unit circuit 56[q] as a gradation signal S during a time period of a horizontal scanning period H when the selection signal SEL[q] becomes the active level.

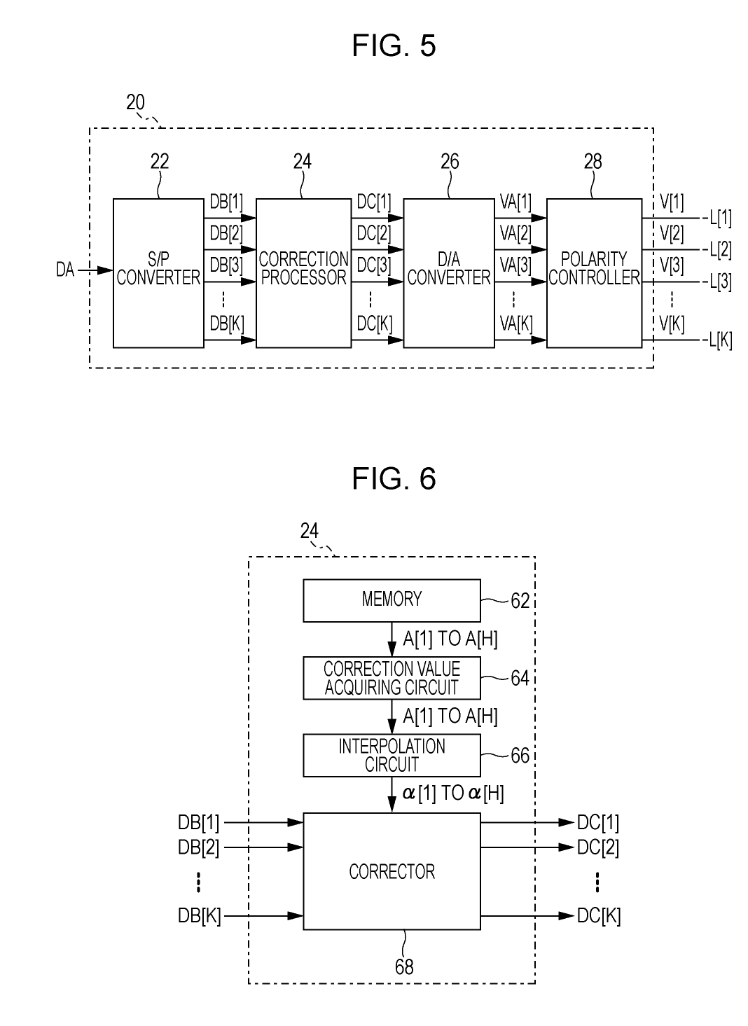

The image processor 20 of FIG. 1 generates image signals V[1] to V[K] of a K system from a digital image data DA designating a gradation value G of each pixel P. FIG. 5 is a block diagram illustrating an image processor 20. As illustrated in FIG. 5, the image processor 20 includes a serial to parallel (S/P) converter 22, a correction processor 24, a digital to analog (D/A) converter 26, and a polarity controller 28. The S/P converter 22 generates image data DB[1] to DB[K] of a K system by phase evolution (S/P conversion) distributing the image data DA in a K systematic fashion and extending them by K times in a time axis.

The correction processor 24 corrects image data DB[1] to DB[K] of a K system generated by the S/P converter 22, respectively, and generates image data DC[1] to DC[K] of a K system. The D/A converter 26 converts image data DC[1] to DC[K] of a K system processed by the correction processor 24 into analog image signals VA[1] to VA[K], respectively.

The polarity controller 28 controls each polarity of image signals VA[1] to VA[K] of a K system processed by the D/A converter 26 with reference to a predetermined reference electric potential VC (for example, electric potential of common electrode 423) to generate image signals V[1] to V[K] of a K system. As illustrated in FIG. 3, a polarity of the image signal V[k] is inverted (frame inversion) for each vertical scanning period F between a positive polarity indicating a higher side of the reference electric potential VC and a negative polarity indicating a lower side of the reference electric potential VC. A configuration (line conversion) of inverting a polarity of each image signal V[k] for each horizontal scanning period H or a configuration (dot inversion) of inverting a polarity by neighboring pixels P in X a direction or a Y direction may be adopted. Moreover, a processing order by the S/P converter 22, the correction processor 24, the D/A converter 26, and the polarity controller 28 may be appropriately changed.

FIG. 6 is a block diagram illustrating a correction processor 24. As illustrated in FIG. 6, the correction processor 24 includes a memory 62, a correction value acquiring circuit 64, an interpolation circuit 66, and a corrector 68. For example, the memory 62 is configured by a non-volatile memory such as a Read Only Memory (ROM) or an Erasable Programmable ROM (EPROM), and stores correction values A[1] to A[H] corresponding to H (H is a natural number equal to or greater than 2) reference locations R set to be spaced apart from each other in an X direction in the pixel unit 10 as illustrated in FIG. 7. The number H of the correction values A[1] to A[H] is less than the number N of the signal lines 14. For example, the correction value A is prepared for each area obtained by dividing the pixel unit 10 by H equal division in an X direction.

The correction value acquiring circuit 64 of FIG. 6 acquires H correction values A[1] to A[H] corresponding to each reference location R from the memory 62. The interpolation circuit 66 generates N (N corresponding to each column signal line 14) correction values α[1] to α[N] corresponding to each location in an X direction in the pixel unit 10 from H correction values A[1] to A[H] acquired by the correction value acquiring circuit 64. Specifically, the interpolation circuit 66 computes a correction value α[n] of each signal line 14 between two reference locations R neighboring each other in an X direction by interpolating two correction values A[h](h=1−H) acquired by the correction value acquiring circuit 64 with respect to each reference location R of both sides of the location. A known interpolation calculation such as straight-line interpolation is optionally adopted as the interpolation of the correction value A[h]. The correction value α[n] of each signal line 14 corresponding to the reference location R is set to a correction value A[h] acquired by the correction value acquiring circuit 64 with respect to the reference location R.

The corrector 68 of FIG. 6 corrects a gradation value G designated by image data DB[k] with respect to an n-th column pixel P in the pixel unit 10 according to a correction value α[n] computed by the corrector 66 with respect to an n-th column to output image data DC [k](DC[1] to DC [K]) indicating a gradation value G after the correction. The image data DC[1] to DC[K] corrected by the corrector 68 is used to generate image signals V[1] to V[K] supplied to the D/A converter 26.

Specifically, the corrector 68 adds a correction value α[n] to a gradation value G indicated by image data DB[k] during a vertical scanning period F when an image signal V[k] (gradation signal S) is set to a positive polarity, and subtracts the correction value α[n] from the gradation value G indicated by image data DB[k] during a vertical scanning period F when an image signal V[k] (gradation signal S) is set to a negative polarity. Accordingly, as illustrated in FIG. 3, when the correction value α[n] is an integer number (+), regardless of a polarity (positive polarity/negative polarity) of the image signal V[k], an electric potential of the image signal V[k] is changed to a higher side in comparison with a non-correction time (α[n]=0). When the correction value α[n] is a negative number (−), regardless of a polarity of the image signal V[k], an electric potential of the image signal V[k] is changed to a lower side in comparison with the non-correction time.

The corrector 68 may separately set presence of correction for the image data DB[1] to DB[K] of a K system, respectively. For example, as disclosed in JP-A-2006-47971, when a vertical line irregularity corresponding to a boundary of each block B[q] occurs, correcting applying a correction value α[n] with respect to image data DB[1] of a first system and image data DB[K] of a K-th system among image data DB[1] to DB[K] of a K system provided from the S/P converter 22 is performed. For example, H correction values A[1] to A[H] of each reference location R before delivery of the electro-optical device 100 are stored in a memory 62 experimentally or statistically selected such that a display gradation of each pixel P is equalized (specifically, a difference of display gradation of each pixel P is included in a predetermined range) when a common gradation value G is designated to image data DA in all pixels P of the pixel unit 10 and image signals V[1] to V[K] corrected by correction values α[1] to α[N] are supplied to the signal line driver 34.

In the first embodiment, since a correction value α[n] is separately computed with respect to each location in an X direction in the pixel unit 10, although a degree of a gradation irregularity such as a vertical line irregularity is different according to a location of the X direction, uniform display may be implemented by effectively reducing a gradation irregularity of each location. Moreover, since correction values α[1] to α[N] are computed for each column in the pixel unit 10 by interpolation of H correction values A[1] to A[H] stored in the memory 62, a storage capacity necessary in the memory 62 is reduced in comparison with, for example, a configuration of storing N correction values α[1]α[N] corresponding to each column in the memory 62. That is, in the first embodiment, it would be advantageous that the reduction in a storage capacity of the memory 62 and the reduction in the gradation irregularity may be compatible with each other at a high level.

### Second Embodiment

Hereinafter, a second embodiment of the invention will be described. If operations and functions of the illustrative embodiment are the same as those in the first embodiment, each description may be appropriately explained using reference numerals referred in the foregoing description.

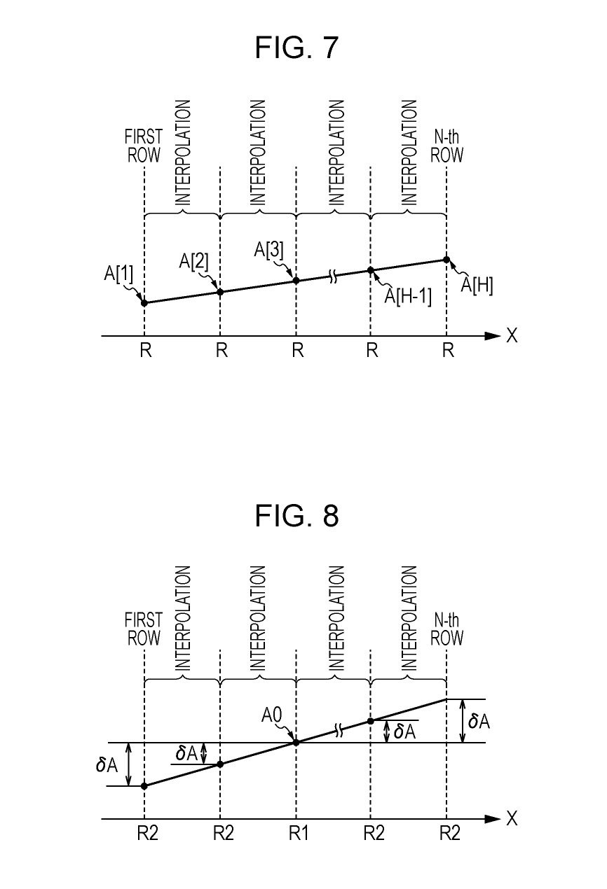

FIG. 8 is a diagram illustrating a content storage of a memory 62 according to a second embodiment. H reference locations R arranged in an X direction in the pixel unit 10 are divided into one reference location R1 (referred to as “first reference location” hereinafter) selected from the H reference locations R and remaining (H−1) reference locations R2 (referred to as “second reference location” hereinafter). For example, the first reference location R1 is a center in the X direction in the pixel unit 10. A correction value A0 of the first reference location R1 is stored in the memory 62, for example, and is changed according to instruction from an exterior with respect to the first reference location R1. On the other hand, with respect to (H−1) second reference locations R2 of H reference locations R, a relative value (differential value) δA of a correction value A[h] using a correction value A0 of a first reference location R1 as a reference is stored in the memory 62.

The correction value acquiring circuit 64 generates H correction values A[1] to A[H] of each reference location R(R1, R2) using a correction value A0 of a first reference location R1 and a relative value δA of each second reference location R2. Specifically, the correction value acquiring circuit 64 computes a correction value A[h](A[h]=A0−δA) with respect to (H−1) second reference locations R2, respectively, by adding a relative value δA of the second reference value R2 and a correction value A0 of the first reference location R1 stored in the memory 62. A correction value A0 stored in the memory 62 is determined as a correction value A[h] of the first reference location R1. The interpolation circuit 66 generates N correction values α[1] to α[N] in the same manner as in the first embodiment using H correction values A[1] to A[H] created in the forgoing order. An operation of the corrector 68 is the same as that of the first embodiment.

The same effect of the second embodiment is realized as that of first embodiment. Further, in the first embodiment, when only the same variation amount in H correction values A[1] to A[H] corresponding to each reference location R is changed, there is a need to vary all of the H correction values A[1] to A[H] stored in the memory 62. In the second embodiment, since a relative value δA of a correction value A[h] using a correction value A0 of a first reference location R1 as a reference is stored in a memory 62 with respect to each second reference location R2, if a correction value A0 of the first reference location R1 is changed, there is not a need to change a stored content of the memory 62 with respect to (H−1) second reference locations R2. Accordingly, in the second embodiment, it is advantageous that a change in the correction values A[1] to A[H] of the each reference location R is easier in comparison with the first embodiment.

### Modified Example

The respective illustrative embodiments may be variously modified. An aspect of a specific modification will now be illustrated. Two or more aspects optionally selected may be appropriately combined with each other if they are not mutually contradictory.

(1) In the foregoing illustrative embodiment, supply of a gradation signal S to the signal line 14 is performed in a time division scheme for each block B[q], but the specific configuration of the signal line driver 34 (supply method of gradation signal S to each signal line 14) may be changed. For example, as disclosed in JP-A-2010-91967, since a periodic vertical line irregularity may occur for each block B[q] in a configuration for performing a process supplying a gradation signal S to K signal lines 14 of each block B[q] with respect to Q blocks B[1] to B[Q] in the time division scheme in parallel, respectively, or a configuration in which the signal line driver 34 is mounted for each block B[q] as a separate IC chip, may be used.

(2) In the foregoing illustrative embodiment, while H reference locations R are set at the same interval in an X direction, a method of selecting and the number of the respective reference locations R may vary. For example, the H reference locations R may be set (H reference location may be unequally distributed) such that an interval of two reference locations R neighboring each other is changed according to a location in an X direction.

(3) The liquid crystal element 42 is merely an example of an electro-optical device which is capable of performing aspects of the invention. As such, there is not a need to distinguish an emissive device emitting light by itself and a non-emissive device (for example, liquid crystal device) changing the transmittance and reflectivity of peripheral light or a current driving device driven by supply of an electric current and a voltage driving device driven by applying an electric field (voltage). For example, the present invention may be applied to an electro-optical device 100 using various electro-optical element such as an organic electroluminescent (EL) device, inorganic EL device, a Light Emitting Diode (LED), a Field-Emission (FE) device, a Surface conduction Electron (SE) emitter device, a Ballistic electron Emitting (BS) device, an electrophoretic display (EPD), or an electrochromic device. That is, the electro-optical device generally includes a driven device (typically a display device the gradation of which is controlled according to a gradation signal S) using an electro-optical material (for example, liquid crystal) the gradation (optical characteristics such as transmittance, luminance, or the like) of which varies by an electric action of current supply or voltage (electric field) application.

### Application Example

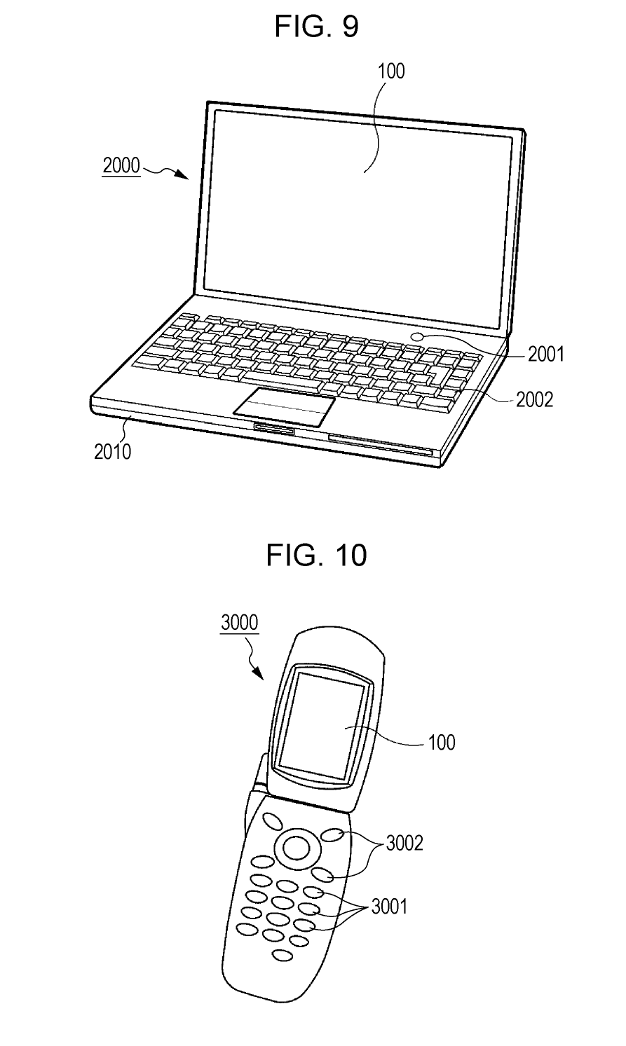

The electro-optical device 100 in the foregoing illustrative embodiments may be used for various types of electronic devices. FIG. 9 to FIG. 11 illustrate specific embodiments of an electronic device using an electro-optical device 100.

FIG. 9 is a perspective view illustrating luggable personal computer using an electro-optical device 100. The personal computer 2000 includes an electro-optical device 100 displaying various types of images and a body unit 2010 in which a power switch 2001 and a keyboard 2002 are provided.

FIG. 10 is a perspective view illustrating a portable phone using an electro-optical device 100. The portable phone 3000 includes a plurality of operation buttons 3001, scroll buttons 3002, and an electro-optical device 100 displaying various types of images. A screen displayed on the electro-optical device 100 is scrolled by operating the scroll buttons 3002.

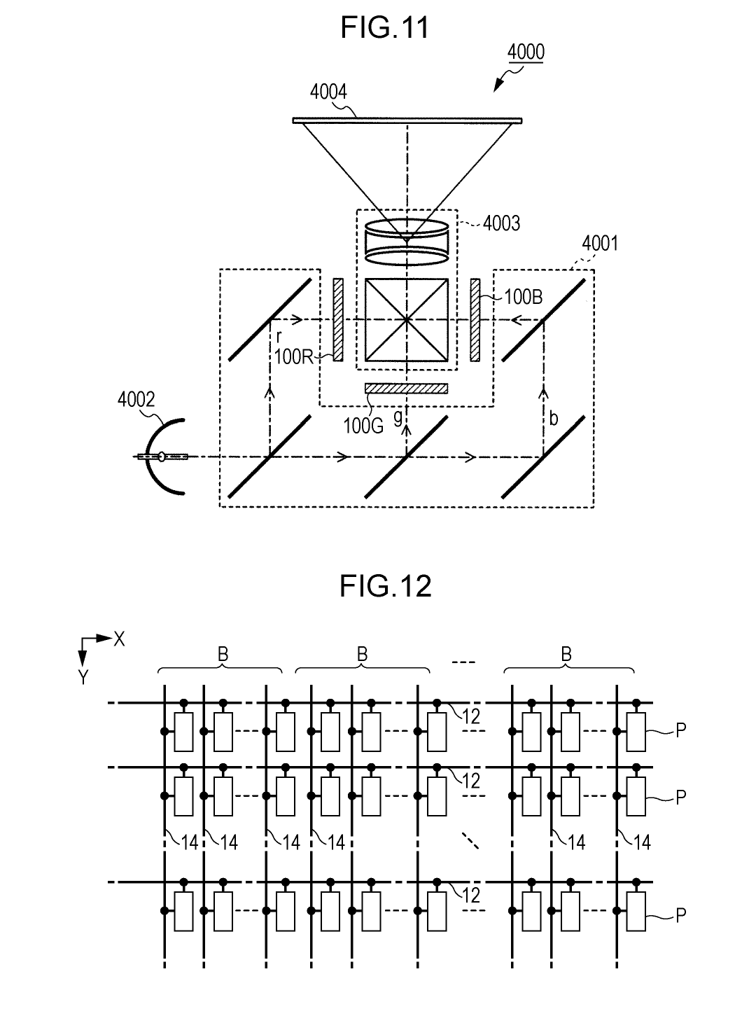

FIG. 11 is a view schematically illustrating a projection display (3 plate type projector) 4000 using the electro-optical device 100. The projection display 4000 includes three electro-optical devices 100 (100R, 100G, 100B) corresponding to display colors (red, green, blue) different from each other. An illumination optical system 4001 supplies a red component r of outgoing light from an illumination device (light source) 4002 to the electro-optical device 100R, supplies a green component g thereof to an electro-optical device 100G, and supplies a blue component b thereof to an electro-optical device 100B. Each of electro-optical devices 100 functions as an optical modulator (light valve) modulating each monochromatic light supplied from the illumination optical system 4001 according to a display image. The projection optical system 4003 combines and projects outgoing light from each of electro-optical devices 100 to a projection surface 4004.

Further, there are Personal Digital Assistants (PDA), a digital still camera, a television, a video camera, a car navigation device, an in-car display (instrument panel), an electronic organizer, an electronic paper, a calculator, a word processor, a workstation, a television phone, a point-of-sale (POS) terminal, a printer, a scanner, a copy machine, a video player, and a device with a touch panel in addition to devices illustrated in FIG. 9 to FIG. 11 which serve as examples of an electronic apparatus to which an electro-optical device 100 according to the present invention may be applied.

What is claimed is:

1. An image processing device comprising:
a first memory storing an image signal corresponding to a pixel arranged in a first direction;
a second memory storing a first correction value corresponding to a first reference location arranged in the first direction and a second correction value corresponding to a second reference location arranged in the first direction;
a correction value computer computing a correction value corresponding to a location between the first reference location and the second reference location based on the first correction values and the second correction value; and
a corrector correcting the image signal of the pixel corresponding to the location based on the correction value.

2. An image processing device comprising:
a first memory storing an image signal corresponding to a pixel arranged in a first direction;
a third memory storing a correction value corresponding to a first reference location arranged in the first direction, and storing a relative value with reference to the correction value of the first reference location corresponding to a second reference location arranged in the first direction;
a first correction value computer computing a correction value of the second reference location from the correction value of the first reference location and the relative value of the second reference location;
a second correction value computer computing a correction value corresponding to a location between the first reference location and the second reference location based on the correction value of the first reference location and the correction value of the second reference location; and
a corrector correcting the image signal of the pixel corresponding to the location based on the correction value computed by the second correction value computer.

3. An electro-optical device comprising:
a plurality of pixels arranged in a first direction and a second direction crossing each other;
a first memory storing an image signal corresponding to a pixel of the plurality of pixels arranged in the first direction;
a second memory storing a first correction value corresponding to a first reference location arranged in the first direction and a second correction value corresponding to a second reference location arranged in the first direction;
a correction value computer computing a correction value corresponding to a location between the first reference location and the second reference location;
a corrector correcting the image signal of the pixel corresponding to the location based on the correction value; and
a driver driving the plurality of pixels arranged in the first direction based on the corrected image signal.

4. An electro-optical device comprising:
a plurality of pixels arranged in a first direction and a second direction crossing each other;
a first memory storing an image signal corresponding to a pixel of the plurality of pixels arranged in the first direction;
a third memory storing a correction value corresponding to a first reference location arranged in the first direction, and storing a relative value with reference to the correction value of the first reference location corresponding to a second reference location arranged in the first direction;
a first correction value computer computing a correction value of the second reference location from the correction value of the first reference location and the relative value of the second reference location;
a second correction value computer computing a correction value corresponding to a location between the first reference location and the second reference location based on the correction value of the first reference location and the correction value of the second reference location;
a corrector correcting the image signal of the pixel corresponding to the location based on the correction value computed by the second correction value computer; and
a driver driving the plurality of pixels arranged in the first direction based on the corrected image signal.

5. An electronic apparatus comprising an electro-optical device according to claim 3.

6. An electronic apparatus comprising an electro-optical device according to claim 4.
